(19) United States
(12) Patent Application Publication
(10) Pub. No.: US 2024/0344470 A1
(43) Pub. Date: Oct. 17, 2024

(54) ROTARY PISTON INTERNAL COMBUSTION ENGINE

(71) Applicant: Winkelmann Wankel GmbH, Frechen (DE)

(72) Inventor: Wolfgang Baier, Obbach (DE)

(21) Appl. No.: 18/633,195

(22) Filed: Apr. 11, 2024

(30) Foreign Application Priority Data
Apr. 12, 2023 (DE) 10 2023 109 201.4

(51) Int. Cl. F01M 11/02; F01M 11/00; F02B 55/08

(52) U.S. Cl. CPC F01M 11/02; F01M 11/0004; F02B 55/08

(57) ABSTRACT

The invention pertains to a rotary piston internal combustion engine for vehicles, aircraft, vessels or a power generation plant, in particular a planetary piston internal combustion engine. The rotary piston internal combustion engine has a housing including an annular casing, on the sides of which an end-side lateral part and an output-side lateral part are provided and in which a trochoidal trajectory is provided, wherein the casing is traversed by an eccentric shaft mounted in the end-side and output-side lateral parts to the eccentric cam of which a piston rotor is connected, wherein three mutually sealed working chambers are formed in the trochoidal trajectory by rotation of the eccentric shaft by the piston rotor, wherein the piston rotor is provided with sealing elements to seal the working chambers against the trochoidal trajectory and the two lateral parts and an oil inlet and an oil outlet provided in the lateral parts for oil, which serves to lubricate and cool components provided in the piston, into an oil pan, characterized by the fact that the oil outlet can be positioned independently of an installation position of the rotary piston engine relative to the oil pan.

### CROSS-REFERENCE TO RELATED APPLICATIONS

This patent application claims priority to German utility patent application number 10 2023 109 201.4 filed Apr. 12, 2023 and titled “rotary piston internal combustion engine”. The subject matter of patent application number 10 2023 109 201.4 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention relates to a rotary piston internal combustion engine for use in vehicles, aircraft, vessels or a power generation plant, in particular a planetary piston internal combustion engine.

### BACKGROUND

Planetary piston engines of this generic type are known in various designs. For example, DE 1 451 808 C discloses a planetary piston internal combustion engine of trochoidal design, with a cooled, triangular piston rotating within a casing cooled axially on both sides by cooled lateral parts with a double-arched contour. This planetary piston internal combustion engine is characterized by the fact that the piston is oil-cooled and that the lateral parts and the casing are liquid-cooled. The planetary piston internal combustion engine is based on a compact and cost efficient design and is suitable for the propulsion of aircraft and motor vehicles due to its small space requirements.

In order to create a planetary piston engine with the lowest possible system-power-to-weight-ratio, DE 101 24 560 B4 discloses a planetary piston engine of trochoidal design with a rotor housing, two side discs, an eccentric shaft mounted in the side discs, a rotor mounted on the eccentric cam of the eccentric shaft and a pressurized oil supply device for supplying oil to the bearings in the side discs and the bearing of the rotor on the eccentric cam.

Rotary piston internal combustion engines of this generic type are used in motor vehicles, motorbikes and vessels. Since the disadvantages of rotary piston internal combustion engines, particularly those designed as planetary piston internal combustion engines, when using conventional fuels no longer occur, at least to the known extent, when using CO₂-free fuels such as hydrogen, new fields of application become available for these internal combustion engines or motors. However, the design requirements are not insignificant even when rotary piston internal combustion engines are used in motor vehicles, motorbikes or vessels as well as power generation plants. The reason can be seen in that the rotary piston internal combustion engines have to be adapted to many different space requirements or operating or assembly conditions, respectively. For example, the arrangement of water or air cooling devices, fuel supply lines, exhaust gas discharge lines and, finally, space requirements for the respective planetary piston internal combustion engines in motor vehicles differ from those in motorbikes, vessels or aircraft. In order to enable a specific application, it may occur that the spatial positions of the eccentric shafts of the planetary piston internal combustion engines differ from one another and therefore require design modifications to be made to the respective planetary piston engine.

The installation position of conventional engines or motors is determined by an oil pan being positioned below. This means that the intake manifold, exhaust systems, spark plugs and water inlet and outlet must fit into the given installation space, since the engine package cannot be separated from the oil pan.

JP S51-74 602 U and DE 10 2011 117 647 A1 are also known.

### SUMMARY

It is the object of the present invention to provide a rotary piston internal combustion engine that can be adapted to different operating conditions.

The invention achieves this object with a rotary piston internal combustion engine according to the claim.

### BRIEF DESCRIPTION OF THE DRAWINGS

In the following, the invention is further explained below with reference to an exemplary embodiment in conjunction with the accompanying drawings.

FIG. 1 shows a perspective view of a first end side of a planetary piston internal combustion engine according to the invention;

FIG. 2 shows a view of an output side of the planetary piston internal combustion engine according to the invention;

FIG. 3 shows a sectional view along line III-III in FIG. 2; and

FIG. 4 shows a sectional view through the planetary piston internal combustion engine according to the invention along line IV-IV in FIG. 3.

### DETAILED DESCRIPTION

Accordingly, the invention provides a rotary piston internal combustion engine for a motor vehicle, motorbike, vessel, aircraft or a power generation plant, in particular a planetary piston internal combustion engine with a housing with an annular casing, on the sides of which an end-side lateral part and an output-side lateral part are provided and in which a trochoidal trajectory is provided, and with an oil inlet and oil outlet provided in the lateral parts for oil, which serves to lubricate and cool components provided in the trochoidal trajectory, into an oil pan. In the rotary piston internal combustion engine, the casing is traversed by an eccentric shaft mounted in the end-side and output-side lateral parts, to the eccentric cam of which a piston rotor is connected. By rotating the eccentric shaft, the piston rotor forms three mutually sealed working chambers in the trochoidal trajectory, wherein the piston rotor is provided with sealing elements to seal the working chambers against the trochoidal trajectory and the two lateral parts. The rotary piston internal combustion engine is characterized by the fact that the oil outlet can be positioned independently of the installation position of the rotary piston internal combustion engine in the motor vehicle, motorbike, aircraft, vessel, or power generation plant relative to the oil pan.

The invention provides the advantage of being able to easily perform operational adjustments on the rotary piston internal combustion engine. The flexibility achieved in this way results in favorable manufacturing costs and greatly enlarges the field of application of the rotary piston internal combustion engine according to the invention.

Further advantages are apparent from the sub-claims.

In one embodiment of the rotary piston internal combustion engine according to the invention, the oil outlet can be fitted independently of the installation position of the annular casing, housing or rotary piston internal combustion engine in the motor vehicle, motorbike, vessel, aircraft or power generation plant for gravity-driven or gravity-assisted drainage of the oil into the oil pan. This facilitates oil drainage into the oil pan.

In a further embodiment, the oil outlet can be positioned in a plane that intersects the eccentric shaft at right angles relative to the position of the oil pan.

Preferably, the oil outlet in the rotary piston internal combustion engine according to the invention is provided on an oil drainage device which is arranged on the output-side lateral part so as to be rotatable in a plane perpendicular to the eccentric shaft.

In one embodiment of the rotary piston internal combustion engine according to the invention, the oil drainage device can be rotatably positioned at predeterminable angular distances with respect to the output-side lateral part. The oil ejected from the piston collects under gravity in the lower region of the annular space and, in any engine installation position, flows out via some of the downward-pointing holes into the oil drainage device and further into the downward-pointing drain which is connected to the oil collection container.

Preferably, the oil drainage device is designed as an essentially ring-shaped hollow body, from which the oil outlet projects radially downwardly. This makes it easier to rotate or position the oil drainage device with respect to the output-side lateral part.

In a further embodiment of the rotary piston internal combustion engine according to the invention, an annular space surrounding the eccentric shaft in the output-side lateral part is in communication with an interior space of the oil drainage device.

In a preferred embodiment of the rotary piston internal combustion engine according to the invention, the oil drainage device can be positioned rotatably with respect to the output-side lateral part by at least one predeterminable pitch angle of a full angle of three hundred and sixty degrees (360°). The smaller the pitch angle is selected, preferably an angle of thirty degrees (30°) or less, the more finely the oil drainage device can be rotated or displaced in relation to the output-side lateral part. The possibility of displacing the oil drainage device by the pitch angle or a multiple thereof makes it easily possible to achieve the desired positioning of the oil outlet in such a way as to ensure gravity-assisted drainage of the oil into the oil pan.

In a particularly preferred embodiment of the rotary piston internal combustion engine according to the invention, the output-side lateral part has circumferentially spaced-apart threaded holes for receiving screws which serve to secure the oil drainage device. This makes it easily possible to achieve the desired rotation of the oil drainage device with respect to the output-side lateral part. For this purpose, the threaded holes are arranged along the circumference of the output-side lateral part surrounding the eccentric shaft at an angular distance relative to the eccentric shaft corresponding to the pitch angle.

In yet another preferred embodiment of the rotary piston internal combustion engine according to the invention, the oil drainage device can be positioned continuously and rotatably relative to the output-side lateral part. This enables the oil outlet or the oil drainage device to be optimally aligned with the oil pan.

Furthermore, an oil vent hole can preferably be provided on the oil drainage cover. The oil vent hole can be designed for hose nozzles, for example.

It will be appreciated that the rotary piston internal combustion engine according to the invention, in particular a planetary piston internal combustion engine, can be designed as a single-piston internal combustion engine with one piston or as an internal combustion engine with several pistons.

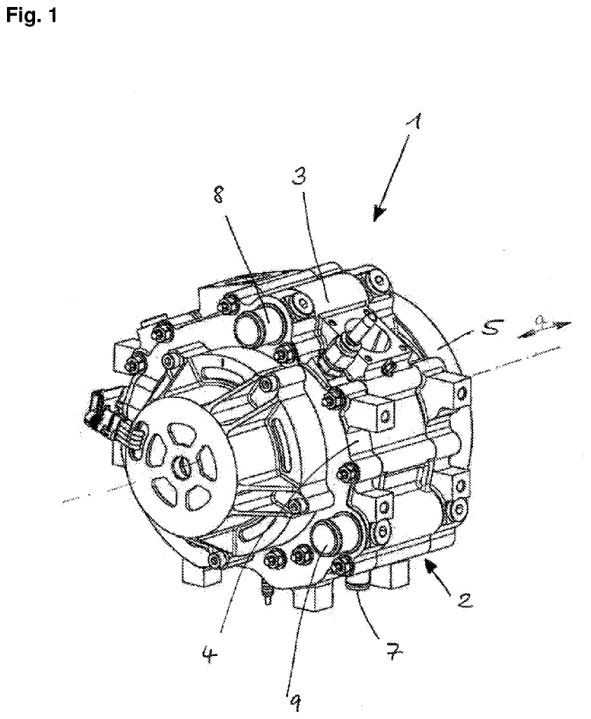

A rotary piston internal combustion engine designed as a planetary piston internal combustion engine, designated with reference numeral 1 in FIG. 1, has a housing 2, the central component of which is an annular casing 3, on which an end-side lateral part 4 and an output-side lateral part 5 are provided on opposite sides in the axial direction a. Oil used to lubricate and cool the moving or rotating parts in the planetary piston internal combustion engine 1 is supplied via an oil inlet 6 on the end-side lateral part 4 and is discharged again via an oil outlet 7 into an oil pan, not shown, located below the housing 2. Water inlets and outlets 8 and 9 of the bushing type are provided on the annular casing 3 to cool the planetary piston internal combustion engine 1. Cooling water flows in from the water inlet 8 via circular openings 11 or 12 into the interior of the casing 3 or the lateral parts 4, 5. It will be appreciated that the ring-shaped casing 3, the end-side lateral part 4 and the output-side lateral part 5 are sealed against each other with corresponding sealing elements in a manner known per se. The oil ejected from the piston collects under gravity in the lower region of the annular space 34 and, in any engine or motor installation position, flows out via some of the downward-pointing holes 36 into the oil drainage device 37 and further into the downward-pointing drain 7, which is connected to the oil collection container. The oil drainage device 37 has an engine vent 180° offset to the oil outlet 7.

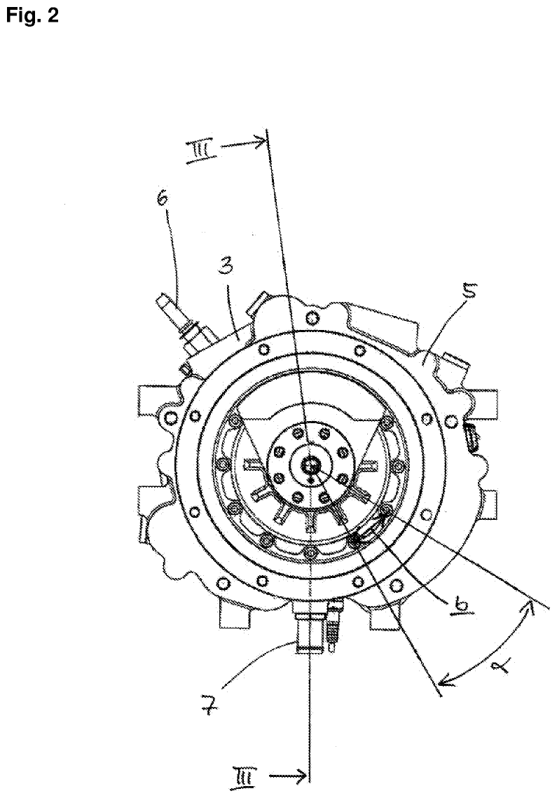

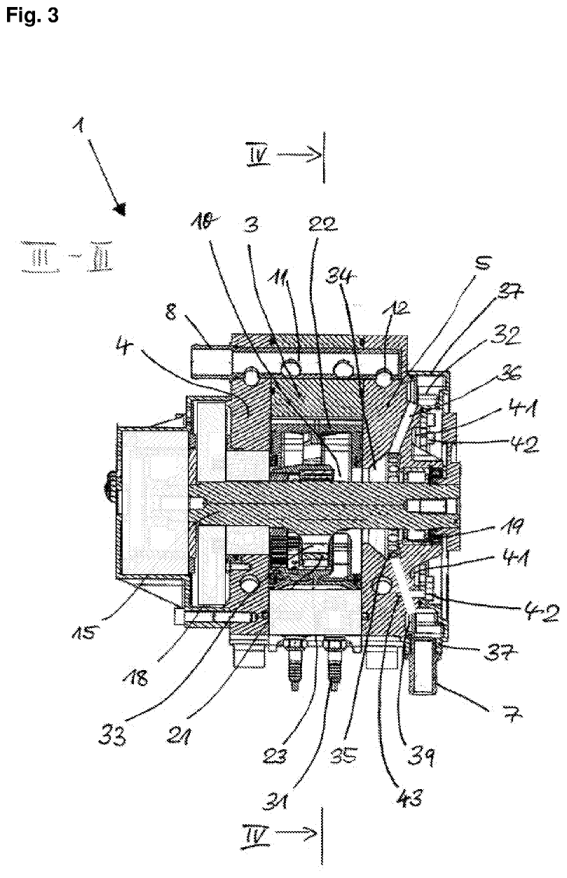

As shown in FIG. 2, the oil inlet 6 is provided in the upper region of the end-side lateral part 4 in accordance with the installation position of the illustrated planetary piston internal combustion engine 1. The oil is fed to the oil outlet 7, which is located axially symmetrically at the lowest point of the output-side lateral part 5, through a passage or channel system shown in more detail in FIG. 3 and designated with reference numeral 10. In an operating state of the planetary piston internal combustion engine 1, clutch housings or gearbox units not shown are connected to the output-side lateral part 5 shown in FIG. 2 in a manner known per se.

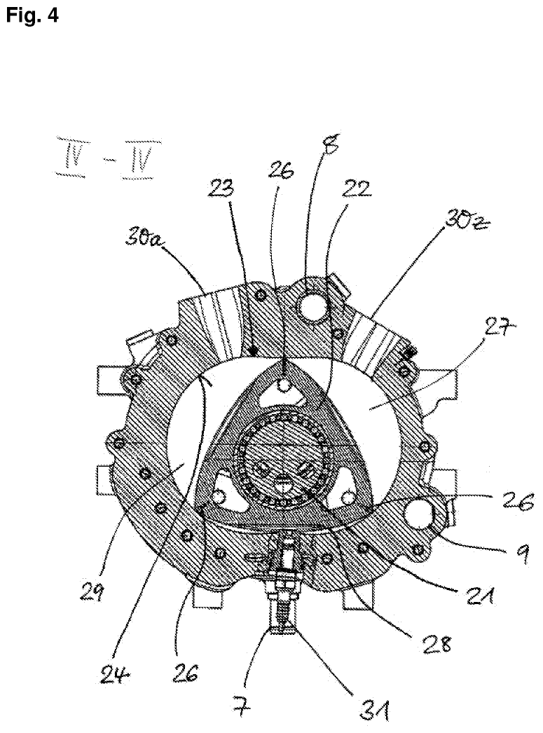

According to FIG. 3, the annular casing 3 is traversed by an eccentric shaft 15, which is mounted in the end-side lateral part 4 and the output-side lateral part 5 with the aid of bearings 18, 19. A piston rotor 22 is attached to an eccentric cam 21 of the eccentric shaft 15, which rotates in a working chamber 23 with a trochoidal inner surface 24 (FIG. 4) driven by the eccentric shaft 15. The piston rotor 22, which is driven by the eccentric shaft 15 and has a cross-section in the shape of an arched triangle, rotates in the working chamber 23 in such a way that its center is guided on a circular path. A synchronized gear is used to set the speed of the piston rotor 22 on the eccentric cam 21 to one third of the speed of the eccentric shaft 15.

Sealing strips 26 are attached to the sides of the piston rotor 22, which are arranged in a triangular shape in relation to each other. The sealing strips 26 lie against the trochoidal inner surface 24 of the working chamber 23 and form three working chambers 27, 28, 29, which increase and decrease their volume twice during one revolution of the piston rotor 22. Using a fuel-air mixture supplied via a supply opening 30z, the working cycles of intake, compression, ignition and discharge of the fuel-air mixture are each performed at the same location during one revolution of the piston rotor 22 with the participation of the spark plugs 31 (FIG. 3) assigned to the working chamber 28 to generate the four-stroke process, the generated rotational force or torque can be used to drive the vehicle, motorbike or vessel that accommodates the planetary piston internal combustion engine 1 or the power generation unit in a factory or residential building that accommodates the planetary piston internal combustion engine 1.

The oil introduced for lubrication and also for cooling via the oil inlet 6 with the aid of well-known oil pumps and expelled via the oil outlet 7 into the oil pan, which is not shown, is pumped through the piston and the output-side lateral part 5 from the end-side lateral part 4 along the passage or channel system shown collectively with reference numeral 10, as illustrated in FIG. 3 (it is not shown in FIG. 3).

In FIG. 3, the oil drainage device 37 is sealed against the output-side lateral part 5 by means of sealing rings 38, 39 and is secured in a ring recess 41 of the output-side lateral part 5. Threaded screws 42 are screwed into threaded holes 43 for this purpose. On the oil drainage device 37, the oil outlet 7 is provided radially in such a way that the oil can drain in a gravity-assisted manner into the oil pan generally located at the bottom of a drive motor or engine such as the planetary piston internal combustion engine 1 described herein.

If the respective object of use of the planetary piston internal combustion engine 1 such as a motor vehicle, a motorbike, an aircraft, a vessel or a power generation plant provided in a building, for example, makes it necessary to change the installation position with regard to a restriction of the housing 2, if the oil drainage device 37 or the oil outlet 7 were to be rigidly positioned, it may no longer be possible to directly allocate the oil or to drain the oil from the outlet 7 into the oil pan with the aid of gravitational force. In order to resolve such a situation, the threaded holes 43 in the annular recess 41 of the output-side lateral part 5 are spaced apart in arc sections according to the invention (symbolized by the arrow b in FIG. 2), which correspond to a predeterminable pitch angle α of a full circle.

As shown in FIG. 2, a preferred pitch angle α is thirty degrees, so that twelve threaded holes 43 are provided equidistantly along the circumference of the annular recess 41 of the output-side lateral part 5 to accommodate the threaded screws 42. The oil drainage device 37 can thus be rotated by 30° or a multiple of an angle of 30°, for example, in a plane running perpendicular to the eccentric shaft 15 relative to the latter or the output-side lateral part 5 and arranged in corresponding positions, each offset by an angle of 30° or a multiple thereof. This ensures that the oil outlet 7 can occupy different positions along the circumference of the output-side lateral part 5 or the cover-like oil outlet device 37. The criterion for its positioning is a downward-pointing and thus gravity-assisted drainage of the oil into the oil pan. This is a simple way of ensuring that the oil drains properly on site in the respective object of use for the planetary piston internal combustion engine 1 according to the invention.

1. Rotary piston internal combustion engine for vehicles, aircraft, vessels or a power generation plant, in particular a planetary piston internal combustion engine
with a housing including an annular casing, on the sides of which an end-side lateral part and an output-side lateral part are provided and in which a trochoidal trajectory is provided,
wherein the casing is traversed by an eccentric shaft which is mounted in the end-side and output-side lateral parts and with the eccentric cam of which a piston rotor is connected,
wherein three mutually sealed working chambers are formed in the trochoidal trajectory by rotation of the eccentric shaft by the piston rotor,
wherein the piston rotor is provided with sealing elements for sealing the working chambers with respect to the trochoidal trajectory and the two lateral parts, and with an oil inlet and an oil outlet provided in the lateral parts for oil, which serves to lubricate and/or cool components provided in the trochoidal trajectory, into an oil pan, characterized in that the oil outlet can be positioned independently of an installation position of the rotary piston engine relative to the oil pan.

2. Rotary piston engine according to claim 1, characterized in that the oil outlet can be mounted independently of an installation position of the rotary piston engine for gravity-assisted drainage of the oil into the oil pan.

3. Rotary piston internal combustion engine according to claim 1, characterized in that the oil outlet can be variably positioned in a plane intersecting the eccentric shaft at right angles relative to the position of the oil pan.

4. Rotary piston internal combustion engine according to claim 1, characterized in that the oil outlet is provided on an oil drainage device which is arranged on the output-side lateral part so as to be rotatable in a plane perpendicular to the eccentric shaft.

5. Rotary piston internal combustion engine according to claim 4, characterized in that the oil drainage device can be positioned rotatably at predeterminable angular distances relative to the output-side lateral part.

6. Rotary piston internal combustion engine according to claim 4, characterized in that the oil drainage device is designed as an annular hollow body, from which the oil outlet projects radially.

7. Rotary piston internal combustion engine according to claim 6, characterized in that an annular space surrounding the eccentric shaft in the output-side lateral part is in communication with an interior space of the oil drainage device via holes provided radially through 360°.

8. Rotary piston internal combustion engine according to one of claim 4, characterized in that the oil drainage device can be positioned displaceably relative to the output-side lateral part by a predeterminable pitch angle of a full angle of three hundred and sixty degrees.

9. Rotary piston internal combustion engine according to one of claim 4, characterized in that the output-side lateral part has circumferentially spaced-apart holes for receiving screws which serve to secure the oil drainage device.

10. Rotary piston internal combustion engine according to one of claim 4, characterized in that the oil drainage device can be continuously positioned rotatably with respect to the output-side lateral part.
